(19) United States
(12) Patent Application Publication
(10) Pub. No.: US 2026/0149966 A1
(43) Pub. Date: May 28, 2026

(54) ACCESS POINT CAPABILITIES PROTECTION FOR ENHANCED OPEN NETWORKS

(71) Applicant: Cisco Technology, Inc., San Jose, CA (US)

(72) Inventors: Yi Xu, Dublin, CA (US); Abhishek Dhammawat, Cupertino, CA (US)

(21) Appl. No.: 18/958,131

(22) Filed: Nov. 25, 2024

(51) Int. Cl. H04W 12/043; H04W 12/106; H04W 76/10; H04W 76/30

(52) U.S. Cl. CPC H04W 12/043; H04W 12/106; H04W 76/10; H04W 76/30

(57) ABSTRACT

A method is performed by a wireless client configured to communicate with wireless infrastructure equipment. The method comprises: upon connecting to the wireless infrastructure equipment without authenticating to the wireless infrastructure equipment, receiving from the wireless infrastructure equipment an individual probe protection key (IPPK) unique to the wireless client; storing the IPPK; sending to the wireless infrastructure equipment a probe request; receiving from the wireless infrastructure equipment a probe response that includes a message integrity check; validating the message integrity check using the IPPK; and accepting or rejecting the probe response depending on a result of validating.

### TECHNICAL FIELD

The present disclosure relates generally to protection of open wireless networks.

### BACKGROUND

Current IEEE 802.11 standards, including Wi-Fi^{®} 7 and Wi-Fi^{®}8, define protection for beacon transmissions. For beacon protection, all wireless clients (referred to simply as “clients”) that connect to a common basic service set identifier (BSSID) of a wireless access point (AP), receive from the wireless AP a common beacon integrity group temporal key (BIGTK) for that BSSID. The AP and all clients connected to the BSSID employ the BIGTK to protect the integrity of periodic beacon frames transmitted by the AP. For example, the AP appends to the beacon frame a message integrity check (MIC) computed based on the BIGTK and, upon receiving the beacon frame, the client validates the MIC (and thus the beacon frame) using a copy of the BIGTK stored by the client. This avoids beacon tampering and/or AP capabilities modification by an attacker. Such beacon protection assumes the clients are trustable. The assumption is valid when the client connects to the AP using authentication and key management (AKM) techniques that employ client authentication, such as simultaneous authentication of equals (SAE) and IEEE 802.1X (DOT1X)-secure hash algorithm (SHA)-256 (DOT1X-SHA256); however, clients are not authenticated when connecting to an open wireless network that employs opportunistic wireless encryption (OWE) or enhanced open association/connection (collectively referred to as “OWE”).A client and an AP using OWE are referred to as an “OWE client” and an “OWE AP.”

The above-described beacon protection poses a security risk to OWE clients connected to the OWE AP when an attacker (e.g., a malicious client) connects to the BSSID of the OWE AP without authentication, fraudulently acquires the BIGTK from the OWE AP, and then transmits a false beacon “protected” by a beacon MIC based on the fraudulently acquired BIGTK. Legitimate OWE clients on the same BSSID may be misled into accepting the false beacon as genuine because the OWE clients can successfully validate the beacon MIC based on client copies of the BIGTK, hence defeating the beacon protection.

### BRIEF DESCRIPTION OF THE DRAWINGS

FIG. 1 is a block diagram of an example open network environment in which embodiments directed to AP capabilities protection for enhanced open networks may be implemented, according to an example embodiment.

FIG. 2 is a flow diagram implemented in the open network environment to provide protection of the AP capabilities in the OWE networks, according to an example embodiment.

FIG. 3 is a flowchart of an example method of providing the protection of the AP capabilities in the OWE networks performed by a wireless client configured to communicate with wireless infrastructure equipment, according to an example embodiment.

FIG. 4 is a flowchart of an example method of providing the protection of the AP capabilities in the OWE networks performed by the wireless infrastructure equipment, according to an example embodiment.

FIG. 5 illustrates a format of an example information element (IE) that may be used to carry an individual probe protection key (IPPK), according to an example embodiment.

FIG. 6 is an illustration of an example false beacon report sent by a wireless client to the wireless infrastructure equipment, according to an example embodiment.

FIG. 7 illustrates a hardware block diagram of a computing device that may perform functions associated with operations discussed herein, according to an example embodiment.

### DETAILED DESCRIPTION

### Overview

In an embodiment, a method is performed by a wireless client configured to communicate with wireless infrastructure equipment. The method involves: upon connecting to the wireless infrastructure equipment without authenticating to the wireless infrastructure equipment, receiving from the wireless infrastructure equipment an individual probe protection key (IPPK) unique to the wireless client; storing the IPPK; sending to the wireless infrastructure equipment a probe request; receiving from the wireless infrastructure equipment a probe response that includes a message integrity check; validating the message integrity check using the IPPK; and accepting or rejecting the probe response depending on a result of validating.

In another embodiment, a method is performed at wireless infrastructure equipment configured to communicate with a wireless client. The method comprises: upon establishing a connection to the wireless client without authenticating the wireless client, generating an individual probe protection key (IPPK) that is unique to the wireless client and independent of any basic service set identifier; storing the IPPK; sending the IPPK to the wireless client; upon receiving a probe request from the wireless client, computing a message integrity check based on the IPPK, and sending a probe response that includes the message integrity check to the wireless client; and upon the wireless client disconnecting from the wireless infrastructure equipment, deleting the IPPK.

### Example Embodiments

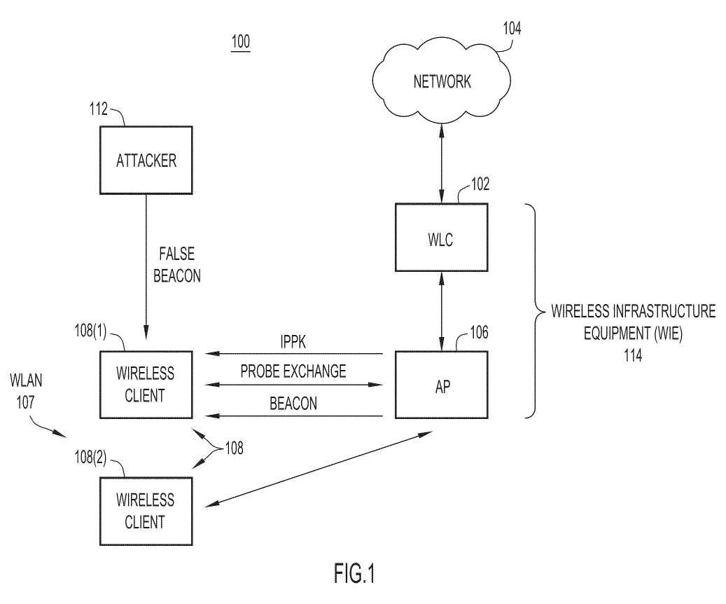

Reference is first made to FIG. 1 for describing the techniques presented to secure open wireless networks. FIG. 1 is a block diagram of an example open network environment 100 in which embodiments directed to access point (AP) capabilities protection for enhanced open networks may be implemented. Open network environment 100 includes a wireless local area network (LAN) (WLAN) controller (WLC) 102 that is connected to and communicates with a network 104. Network 104 may include one or more wide area networks (WANs), such as the Internet, and one or more LANs. WLC 102 also communicates with and controls an AP 106 (e.g., a wireless AP), which serves a WLAN 107 to which wireless clients 108(1) and 108(2) (collectively referred to as “wireless clients 108”) belong. Wireless clients 108(1) and 108(2) may also be referred to as “wireless client devices.” In other examples, more than one AP and more or less than two wireless clients may be present in the WLAN 107. In the example of FIG. 1, open network environment 100 also includes an attacker 112, such as a malicious AP, which attempts to interfere with the normal operation of wireless clients 108 and AP 106 (i.e., the “genuine” AP).

WLC 102 serves as a bridge to transport traffic (e.g., data packets) between network 104 and WLAN 107. Together, WLC 102 and AP 106 represent wireless infrastructure equipment (WIE) 114. AP 106 provides wireless connectivity to wireless clients 108, which access WLC 102 and network 104 through the AP 106. Wireless clients 108 associate/connect to AP 106 in order to establish communication sessions with WIE 114 and exchange frames (including data traffic and management frames) with the AP 106. Once associated/connected to AP 106, wireless clients 108 may exchange traffic (e.g., data packets) with network 104 through AP 106 and WLC 102 during communication sessions, in which case the WLC 102 forwards the traffic between the network 104 and wireless clients 108.

WIE 114 (e.g., AP 106 and WLC 102) and wireless clients 108 operate according to one or more Wi-Fi standards (i.e., IEEE 802.11 standards), including opportunistic wireless encryption (OWE) or enhanced open association/connection (collectively referred to as “OWE”). Thus, WIE 114 and wireless clients 108 collectively comprise an open wireless network. OWE permits wireless clients 108 to connect to WIE 114 without authenticating to the WIE using a password, for example. Once connected, wireless clients 108 operate as “unauthenticated” wireless clients throughout their connection lifetime. The embodiments presented herein modify or extend conventional OWE to protect probe request/response exchanges, validate beacons, and overcome beacon vulnerability (including beacon tampering) for unauthenticated wireless clients. The embodiments provide additional advantages described below.

At a high-level, when wireless client 108(1) employs OWE to connect to WIE 114 without authenticating to the WIE 114, the WIE 114 sends to the wireless client an individual probe protection key (IPPK) according to the embodiments. Wireless client 108(1) and AP 106 exchange a probe request and a probe response (denoted “probe exchange”) in FIG. 1. The probe response advertises AP capabilities (referred to as “probe response-advertised AP capabilities”) to wireless client 108(1). AP 106 periodically transmits a beacon, which also advertises the AP capabilities (referred to as “beacon-advertised AP capabilities”), which match those of the probe response. Attacker 112 may also connect to WIE 114 without authenticating to the WIE, and transmits a false beacon that advertises false AP capabilities (referred to as “false beacon-advertised AP capabilities”) that differ from the AP capabilities advertised in the probe response (and beacon).

The embodiments presented herein overcome open network security shortcomings described above. For example, WIE 114 and wireless client 108(1) employ the IPPK for several protection features not available under the current Wi-Fi standards. First, AP 106 and wireless client 108(1) use the IPPK to protect the probe exchange. More specifically, wireless client 108(1) uses the IPPK to validate the probe response, and thus the probe response-advertised AP capabilities (which become, once validated, “validated probe response-advertised AP capabilities”). Second, wireless client 108(1) validates the beacon using the validated probe response-advertised AP capabilities. More specifically, wireless client 108(1) detects a match between the validated probe response-advertised AP capabilities and the beacon advertised AP capabilities. Third, wireless client 108(1) detects the false beacon also using the validated probe response-advertised AP capabilities, and reports the false beacon to AP 106. More specifically, wireless client 108(1) detects a mismatch between the validated probe response-advertised AP capabilities and the false beacon-advertised AP capabilities. All of the foregoing protections derive directly or indirectly from use of the IPPK by wireless client 108(1) and WIE 114.

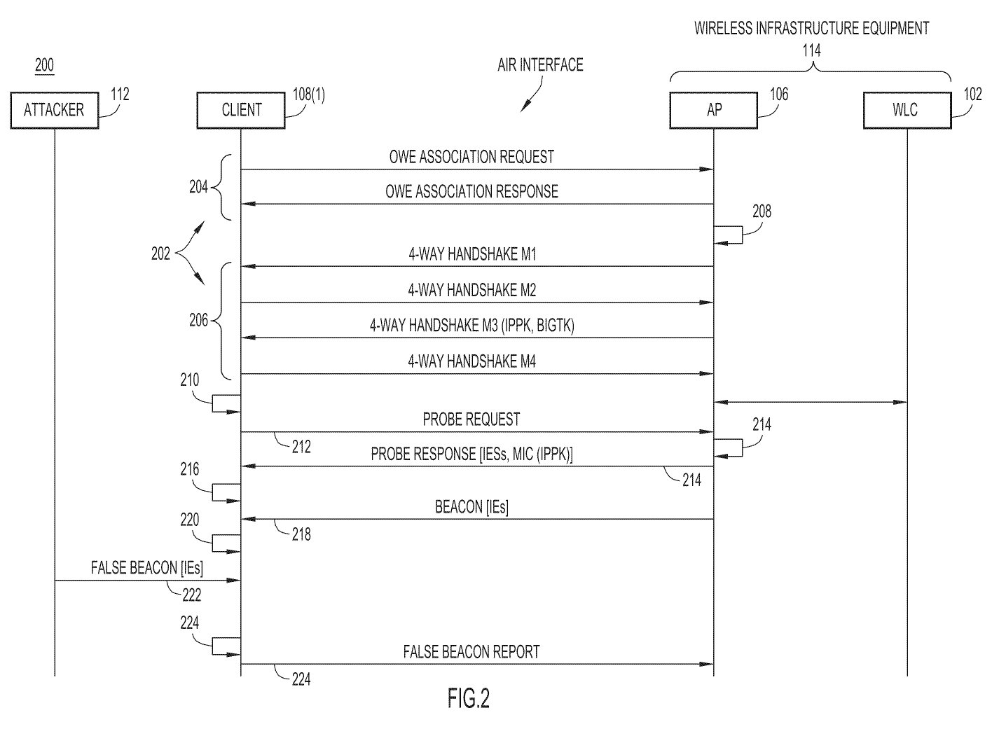

FIG. 2 is a flow (sequence/call flow) diagram depicting operations in open network environment 100 to provide protection of AP capabilities in OWE networks, according to an example embodiment. The flow diagram shows example transactions 200 between/performed by wireless client 108(1), WIE 114, and attacker 112. Operations/transaction performed by WIE 114 may be handled at AP 106, WLC 102, or a combination of the two, except that the AP transmits/receives all messages to/from wireless client 108(1) via an over-the-air (wireless) interface between the two.

At 202, wireless client 108(1) and WIE 114 (e.g., AP 106 or WLC 102) execute an OWE client connection process or flow by which the wireless client connects/associates (i.e., establishes a connection) to WIE 114 without authenticating to the WIE. Wireless client 108(1) remains unauthenticated throughout the lifetime of the client connection. In a first mode, WLC 102 primarily manages/handles the OWE connection process and AP 106 simply forwards messages between the WLC and wireless client 108(1). In a second mode, AP 106 primarily manages/handles the OWE connection process and messages terminate at the AP. In the example of FIG. 2, all messages terminate at AP 106; however, it is understood that the messages may flow to/from WLC 102 through AP 106 in other examples.

The client connection process includes, at 204, an initial exchange of OWE association request/response messages between wireless client 108(1) and WIE 114. Specifically, wireless client 108(1) sends to WIE 114 an OWE association request. Upon receiving the OWE association request, WIE 114 sends to wireless client 108(1) an OWE association response. The client connection process also includes, at 206, a modified extensible authentication protocol over LAN (EAPOL) four-way (i.e., 4-way) handshake between wireless client 108(1) and the WIE 114. The modified EAPOL 4-way handshake is similar to a conventional EAPOL 4-way handshake, except for differences described below.

Concurrent with the client connection process (i.e., upon connection of wireless client 108(1) to WIE 114), at 208, the one of WLC 102 and AP 106 that is primarily managing/handling the client connection process generates an IPPK that is unique to the wireless client. WIE 114 maps/associates the IPPK to an identifier (ID) (e.g., a media access control (MAC) address) of wireless client 108(1). WIE 114 stores an IPPK-to-wireless client ID mapping in memory of the WIE. WIE 114 may access the IPPK in the mapping using the wireless client ID. When WLC 102 generates the IPPK, the WLC sends the IPPK to the AP so that the AP can compute a message integrity code (MIC) for a probe response in later transactions, as will be described below.

The IPPK includes the following properties/features. First, unlike the common BIGTK, which is common to all wireless clients connected to a BSSID of AP 106, the IPPK is unique only to wireless client 108(1). Second, the IPPK is valid for the entire lifetime of the wireless client connection, and does not have to be rotated. Upon tear-down of the wireless client connection, e.g., when wireless client 108(1) disconnects from WIE 114, the WIE deletes the IPPK. Third, in the event that wireless client 108(1) roams (e.g., performs a fast transition (FT) roam under IEEE 802.11r), WIE 114 sends the IPPK to wireless client 108(1) in a roam response message (e.g., in an information element (IE) of an FT reassociation response).

Returning to 206, wireless client 108(1) and WIE 114 (e.g., AP 106 or WLC 102) perform the modified EAPOL 4-way handshake, which includes the following 4-message exchange. First, WIE 114 sends to wireless client 108(1) a message M1. Second, wireless client 108(1) sends to WIE 114 a message M2. Third, WIE 114 sends to wireless client 108(1) a modified message M3 that includes the IPPK. In addition, the message M3 may include a common BIGTK to protect beacon frames. Fourth, wireless client 108(1) sends to WIE 114 a message M4. Thus, the modified EAPOL 4-way handshake exchanges the IPPK and one or more conventional keys to protect the air interface between WIE 114 and wireless client 108(1). The conventional keys may include, but are not limited to, the common BIGTK, a group temporal key (GTK) used to protect broadcast traffic frames, and an integrity group temporal key (IGTK) used to protect management frames. Unlike the IPPK, the conventional keys do not protect probe requests or probe responses.

Upon receiving the IPPK of message M3, at 210, wireless client 108(1) stores a copy of the IPPK in memory of the wireless client.

At 212, wireless client 108(1) originates and sends to WIE 114 (e.g., to AP 106) a probe request that requests/solicits AP capabilities of the AP.

Upon receiving the probe request, at 214, WIE 114 (e.g., AP 106) creates a probe response that includes IEs containing the AP capabilities. The AP capabilities include WLAN parameters supported by the AP. An example list of AP capabilities may include a network type, supported data rates, encryption types, polling support, a frequency-hopping (FH) parameter set, a direct-sequence (DS) parameter set, a contention-free (CF) parameter set, and an independent basic service set (IBSS). AP 106 computes a first MIC for the probe response (i.e., a probe-response MIC) based on contents of the probe response and the IPPK stored at WIE 114. In an example, AP 106 may compute the first MIC as a hash of the contents using the IPPK. AP 106 appends the first MIC to the probe response, and transmits the same to wireless client 108(1).

Upon receiving the probe response, at 216, wireless client 108(1) validates the first MIC of the received probe response based on the copy of the IPPK stored at the wireless client. To do this, first, wireless client 108(1) computes a second MIC based on the contents of the received probe response and the IPPK stored at the wireless client device. Wireless client 108(1) uses the same technique to compute the second MIC that AP 106 used to compute the first MIC. For example, wireless client 108(1) may compute the second MIC as a hash of the contents of the received probe response and the IPPK stored at the wireless client. Second, wireless client 108(1) determines whether the first MIC in the received probe response matches (i.e., is the same as) the second MIC. That is, wireless client 108(1) matches the first MIC to the second MIC.

When a result of the compare indicates a match between the first MIC and the second MIC (i.e., they are the same), wireless client 108(1) declares the first MIC successfully validated, accepts the received probe response, and stores the contents of the received probe response in local memory for later use. Based on the foregoing, the AP capabilities stored in memory are considered valid or validated probe response-advertised AP capabilities. On the other hand, when the result of the compare indicates a mismatch between the first MIC and the second MIC (i.e., they are different), wireless client 108(1) declares the first MIC unsuccessfully validated (i.e., the validating failed), rejects the received probe response, and does not store the contents of the received probe response in local memory for later use.

At 218, AP 106 periodically transmits a beacon having IEs that carry the AP capabilities (referred to as “beacon-advertised AP capabilities”).

Upon receiving the beacon, and assuming the probe response-advertised AP capabilities were successfully validated at 216, at 220, wireless client 108(1) determines whether to trust (i.e., validates) the beacon as follows. Wireless client 108(1) matches the beacon-advertised AP capabilities against the validated probe response-advertised AP capabilities. When they match, wireless client 108(1) declares that the beacon is trusted. In the example of FIG. 1, there is a match, and wireless client 108(1) trusts the beacon. Wireless client 108(1) uses the information provided by the trusted beacon.

At 222, attacker 112 transmits a false beacon having IEs that carry false AP capabilities (referred to as “false beacon-advertised AP capabilities”).

Upon receiving the false beacon, and assuming the probe response-advertised AP capabilities were successfully validated at 216, at 224, wireless client 108(1) determines whether to trust (i.e., validates) the false beacon. Wireless client 108(1) performs the same operations used to validate the beacon at 220. That is, wireless client 108(1) matches the false beacon-advertised AP capabilities against the validated probe response-advertised AP capabilities. When they do not match (i.e., there is a mismatch), wireless client 108(1) declares that the false beacon is not trusted (i.e., is the false beacon). Wireless client 108(1) sends to AP 106 a false beacon report to notify the AP of the possibility of an attacker.

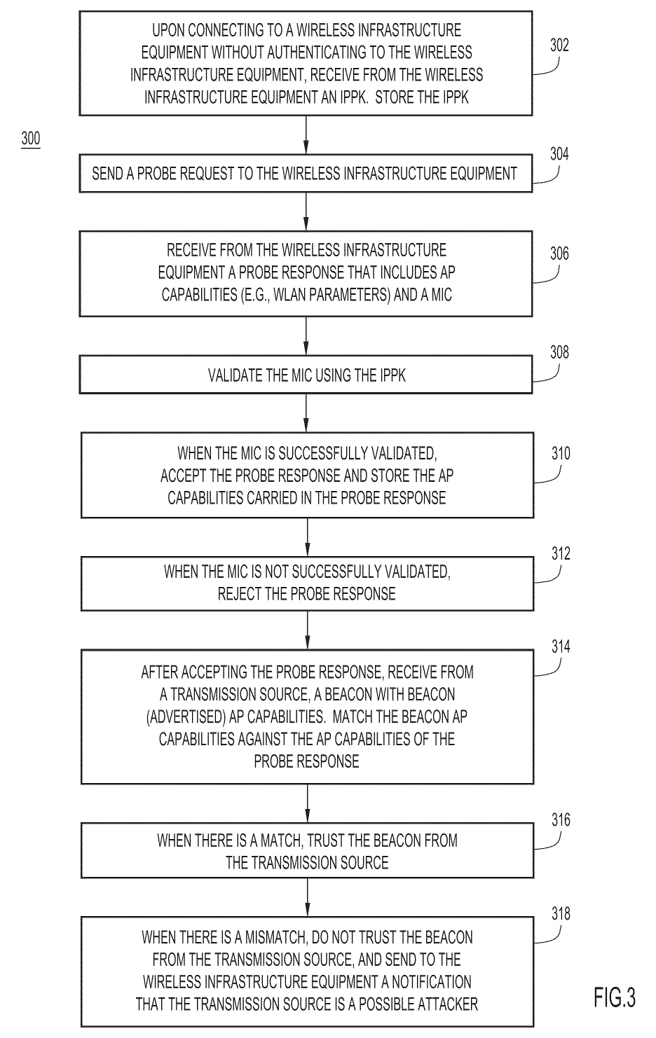

FIG. 3 is a flowchart of an example method 300 of providing protection of AP capabilities in OWE networks performed by a wireless client (e.g., one of wireless clients 108) configured to communicate with wireless infrastructure equipment (e.g., WIE 114). The wireless infrastructure equipment includes a WLC configured to communicate with a wireless AP.

Upon connecting to the wireless infrastructure equipment using OWE without authenticating to the wireless infrastructure equipment, at 302, the wireless client receives from the wireless infrastructure equipment, in a 4-way handshake, an IPPK that is unique to the wireless client and independent of any BSSID. The wireless client stores the IPPK in memory of the wireless client.

At 304, the wireless client sends to the wireless infrastructure equipment a probe request for AP capabilities. In response to sending the probe request, at 306, the wireless client receives from the wireless infrastructure equipment a probe response that includes AP capabilities (e.g., WLAN parameters supported by the AP) and a MIC.

At 308, the wireless client validates the MIC using the IPPK that is stored at the wireless client.

When the MIC is successfully validated (i.e., upon successfully validating the MIC), at 310, the wireless client accepts the probe response. The wireless client declares that the AP capabilities provided in the probe response are valid, and stores them for later use.

When the MIC is not successfully validated, at 312, the wireless client rejects the probe response. More generally, at 310 and 312, the wireless client either accepts or rejects the probe response depending on a result of validating at 308.

Upon/after accepting the probe response (and storing its validated AP capabilities), at 314, the wireless client receives, from a transmission source, a beacon that also advertises AP capabilities (i.e., beacon-advertised AP capabilities). The wireless client performs a match (i.e., attempts to match) of the beacon-advertised AP capabilities against the previously validated AP capabilities provided in the probe response.

When there is a match (i.e., the beacon-advertised AP capabilities are the same as those advertised in the probe response), at 316, the wireless client trusts the beacon from the transmission source.

When there is a mismatch (i.e., the beacon-advertised AP capabilities differ from the AP capabilities advertised in the probe response), at 318, the wireless client does not trust the beacon from the transmission source, and sends to the wireless infrastructure equipment a notification that the transmission source is a possible attacker.

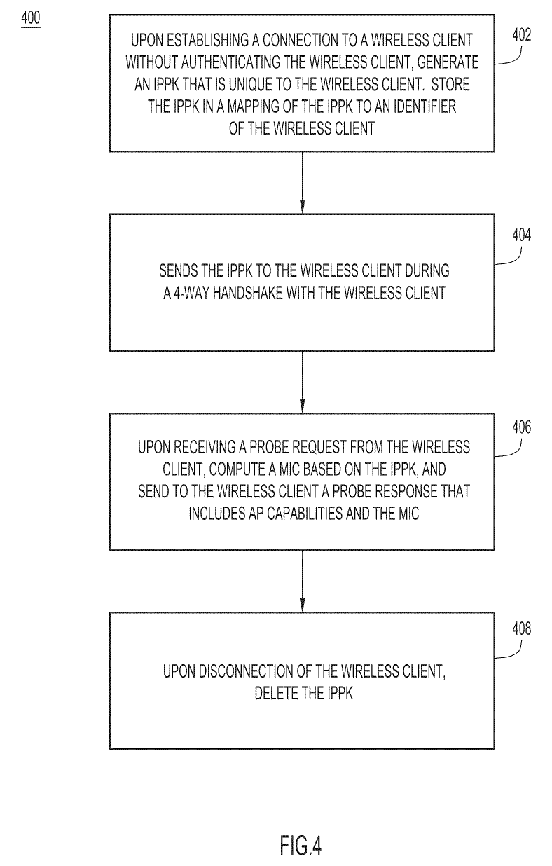

FIG. 4 is a flowchart of an example method 400 of providing protection of AP capabilities in OWE networks performed by wireless infrastructure equipment configured to communicate with a wireless client. The wireless infrastructure equipment includes a WLC configured to communicate with a wireless AP.

Upon establishing a connection to the wireless client using OWE without authenticating the wireless client, at 402, the wireless infrastructure equipment generates an IPPK that is unique to the wireless client and independent of any BSSID. The wireless infrastructure equipment stores the IPPK at the wireless infrastructure equipment.

At 404, the wireless infrastructure equipment sends the IPPK to the wireless client during a 4-way handshake with the wireless client. The wireless infrastructure equipment may also send a common BIGTK to the wireless client.

Upon receiving a probe request from the wireless client, at 406, the wireless infrastructure equipment computes a MIC based on the IPPK, and sends to the wireless client a probe response that includes the MIC.

Upon the wireless client disconnecting from the wireless infrastructure equipment, at 408, the wireless infrastructure equipment deletes the IPPK.

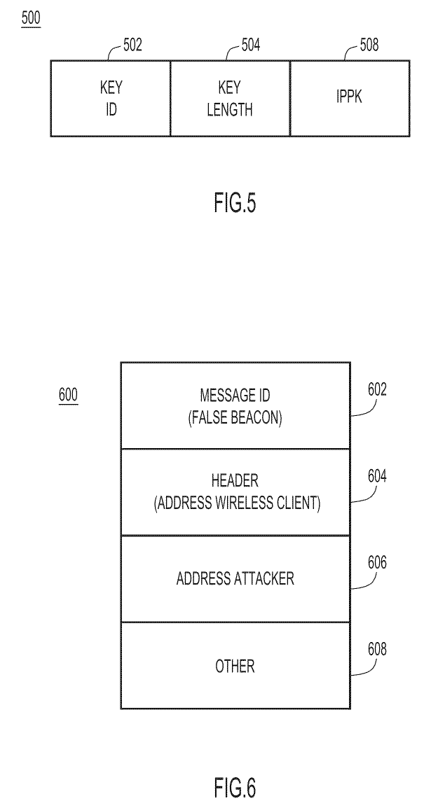

FIG. 5 illustrates a format of an example IE 500 that may be used to carry an IPPK in message M3. IE 500 includes a key ID 502 that indicates the IE carries an IPPK, a key length 504 that indicates a length of the IPPK, and an IPPK 508.

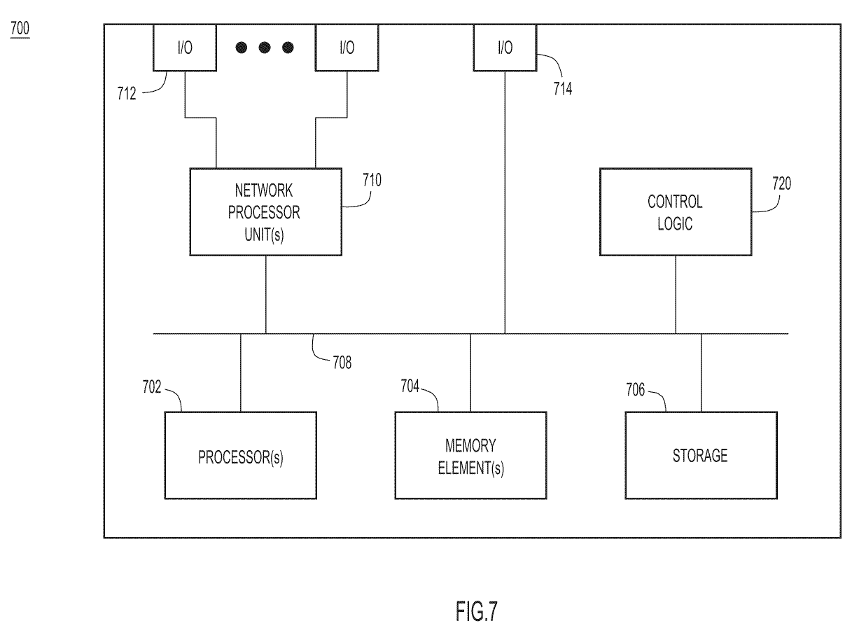

FIG. 6 is an illustration of an example false beacon report 600 sent by a wireless client to an AP. False beacon report 600 includes a message ID 602 that indicates a false beacon is detected, a header 604 that includes address information for the wireless client, address information 606 of a transmission source of the false beacon, and other information 608.

In summary, the embodiments utilize an exchange of a probe request and a probe response to communicate AP capabilities (e.g., WLAN parameters) to an unauthenticated client, and use an IPPK to protect the content of the probe response. The IPPK prevents an attacker from discovering the keys of other clients because the attacker receives a key specific to itself, which is not used by the other clients. The embodiments include (i) generating/distributing the IPPK on unauthenticated client association, and (ii) using the probe request/response exchange (protected by the IPPK) to communicate the AP capabilities to the client in addition to conventional techniques that use a beacon to provide the AP capabilities. The embodiments presented herein may be employed by wireless client devices and wireless infrastructure that operate in accordance with any of the Wi-Fi standards, including, but not limited to, Wi-Fi 6 through Wi-Fi 8 and beyond, for example.

The techniques presented herein can co-exist with current beacon protection using the BIGTK, and provide an additional method by which the unauthenticated client can obtain trustworthy AP capabilities that are not secured by the conventional beacon protection. Additionally, a genuine OWE client (as opposed to an attacker) may use the IPPK to acquire the AP capabilities from a genuine AP using the probe response, and then match the AP capabilities against those advertised in a beacon (referred to as “probe response-based validation”). If the beacon was modified by an attacker (referred to as “beacon tampering”), the match fails, and the probe response-based validation (by the genuine client) detects the beacon tampering, rejects the beacon, and notifies the genuine AP. In response, the genuine AP may generate a new BIGTK to protect subsequent beacon frames. Thus, the IPPK based probe response handling helps detect beacon manipulation by any attacker present in the network.

Referring to FIG. 7, FIG. 7 illustrates a hardware block diagram of a computing device 700 that may perform functions associated with operations discussed herein in connection with the techniques depicted in FIGS. 1-6. In various embodiments, a computing device or apparatus, such as computing device 700 or any combination of computing devices 700, may be configured as any entity/entities as discussed for the techniques depicted in connection with FIGS. 1-6 in order to perform operations of the various techniques discussed herein. Computing device 700 may represent entities of WIE 114, individually or collectively, including WLC 102 and AP 106, and may also represent a wireless client.

In at least one embodiment, the computing device 700 may be any apparatus that may include one or more processor(s) 702, one or more memory element(s) 704, storage 706, a bus 708, one or more network processor unit(s) 710 interconnected with (e.g., coupled to) one or more network input/output (I/O) interface(s) 712, one or more I/O interface(s) 714, and control logic 720. In various embodiments, instructions associated with logic for computing device 700 can overlap in any manner and are not limited to the specific allocation of instructions and/or operations described herein.

In at least one embodiment, processor(s) 702 is/are at least one hardware processor configured to execute various tasks, operations and/or functions for computing device 700 as described herein according to software and/or instructions configured for computing device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term 'processor'.

In at least one embodiment, memory element(s) 704 and/or storage 706 is/are configured to store data, information, software, and/or instructions associated with computing device 700, and/or logic configured for memory element(s) 704 and/or storage 706. For example, any logic described herein (e.g., control logic 720) can, in various embodiments, be stored for computing device 700 using any combination of memory element(s) 704 and/or storage 706. Note that in some embodiments, storage 706 can be consolidated with memory element(s) 704 (or vice versa), or can overlap/exist in any other suitable manner.

In at least one embodiment, bus 708 can be configured as an interface that enables one or more elements of computing device 700 to communicate in order to exchange information and/or data. Bus 708 can be implemented with any architecture designed for passing control, data and/or information between processors, memory elements/storage, peripheral devices, and/or any other hardware and/or software components that may be configured for computing device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 710 may enable communication between computing device 700 and other systems, entities, etc., via network I/O interface(s) 712 (wired and/or wireless) to facilitate operations discussed for various embodiments described herein. In various embodiments, network processor unit(s) 710 can be configured as a combination of hardware and/or software, such as one or more Ethernet driver(s) and/or controller(s) or interface cards, Fibre Channel (e.g., optical) driver(s) and/or controller(s), wireless receivers/ transmitters/transceivers, baseband processor(s)/modem(s), and/or other similar network interface driver(s) and/or controller(s) now known or hereafter developed to enable communications between computing device 700 and other systems, entities, etc. to facilitate operations for various embodiments described herein. In various embodiments, network I/O interface(s) 712 can be configured as one or more Ethernet port(s), Fibre Channel ports, any other I/O port(s), and/or antenna(s)/antenna array(s) now known or hereafter developed. Thus, the network processor unit(s) 710 and/or network I/O interface(s) 712 may include suitable interfaces for receiving, transmitting, and/or otherwise communicating data and/or information in a network environment.

I/O interface(s) 714 allow for input and output of data and/or information with other entities that may be connected to computing device 700. For example, I/O interface(s) 714 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 720 can include instructions that, when executed, cause processor(s) 702 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 720) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term 'memory element'. Data/information being tracked and/or sent to one or more entities as discussed herein could be provided in any database, table, register, list, cache, storage, and/or storage structure: all of which can be referenced at any suitable timeframe. Any such storage options may also be included within the broad term 'memory element' as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 704 and/or storage 706 can store data, software, code, instructions (e.g., processor instructions), logic, parameters, combinations thereof, and/or the like used for operations described herein. This includes memory element(s) 704 and/or storage 706 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as 'messages', 'messaging', 'signaling', 'data', 'content', 'objects', 'requests', 'queries', 'responses', 'replies', etc. which may be inclusive of packets. As referred to herein and in the claims, the term 'packet' may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a 'payload', 'data payload', and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in 'one embodiment', 'example embodiment', 'an embodiment', 'another embodiment', 'certain embodiments', 'some embodiments', 'various embodiments', 'other embodiments', 'alternative embodiment', and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase 'at least one of', 'one or more of', 'and/or', variations thereof, or the like are open-ended expressions that are both conjunctive and disjunctive in operation for any and all possible combination of the associated listed items. For example, each of the expressions 'at least one of X, Y and Z', 'at least one of X, Y or Z', 'one or more of X, Y and Z', 'one or more of X, Y or Z' and 'X, Y and/or Z' can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms 'first', 'second', 'third', etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, 'first X' and 'second X' are intended to designate two 'X' elements that are not necessarily limited by any order, rank, importance, temporal sequence, or hierarchy of the two elements. Further as referred to herein, 'at least one of' and 'one or more of' can be represented using the '(s)' nomenclature (e.g., one or more element(s)).

In some aspects, the techniques described herein relate to a method performed by a wireless client configured to communicate with wireless infrastructure equipment, the method including: upon connecting to the wireless infrastructure equipment without authenticating to the wireless infrastructure equipment, receiving from the wireless infrastructure equipment an individual probe protection key (IPPK) unique to the wireless client, and storing the IPPK; sending to the wireless infrastructure equipment a probe request; receiving from the wireless infrastructure equipment a probe response that includes a message integrity check; validating the message integrity check using the IPPK; and accepting or rejecting the probe response depending on a result of validating.

In some aspects, the techniques described herein relate to a method, wherein: when validating is successful, accepting the probe response; and when validating fails, rejecting the probe response.

In some aspects, the techniques described herein relate to a method, wherein: the IPPK is independent of any basic service set identifier (BSSID) used by the wireless infrastructure equipment.

In some aspects, the techniques described herein relate to a method, wherein: the wireless client is configured to operate according to opportunistic wireless encryption (OWE) or open network authentication that does not use a password for connecting to the wireless infrastructure equipment.

In some aspects, the techniques described herein relate to a method, wherein: connecting without authenticating includes exchanging an open wireless encryption association request and an open wireless encryption association response with the wireless infrastructure equipment.

In some aspects, the techniques described herein relate to a method, further including, by the wireless client: after connecting without authenticating, performing a four-way handshake with the wireless infrastructure equipment, wherein receiving the IPPK includes receiving the IPPK in a message of the four-way handshake.

In some aspects, the techniques described herein relate to a method, further including: receiving from the wireless infrastructure equipment via the four-way handshake a beacon integrity group temporal key (BIGTK) used for protecting beacon frames.

In some aspects, the techniques described herein relate to a method, further including: upon accepting the probe response, receiving, from a transmission source, a beacon that includes beacon-advertised access point capabilities; matching the beacon-advertised access point capabilities against access point capabilities included in the probe response; and trusting or not trusting the beacon based on a result of matching.

In some aspects, the techniques described herein relate to a method, wherein: when the result indicates a match, trusting the beacon; and when the result indicates a mismatch, not trusting the beacon, and sending to the wireless infrastructure equipment a notification that the transmission source is a possible attacker.

In some aspects, the techniques described herein relate to an apparatus including: a network interface unit to communicate with wireless infrastructure equipment; and a processor coupled to the network interface unit and configured to perform: upon connecting to the wireless infrastructure equipment without authenticating to the wireless infrastructure equipment, receiving from the wireless infrastructure equipment an individual probe protection key (IPPK) unique to the apparatus, and storing the IPPK; sending to the wireless infrastructure equipment a probe request; receiving from the wireless infrastructure equipment a probe response that includes a message integrity check; validating the message integrity check using the IPPK; and accepting or rejecting the probe response depending on a result of validating.

In some aspects, the techniques described herein relate to an apparatus, wherein the processor is further configured to perform: when validating is successful, accepting the probe response; and when validating fails, rejecting the probe response.

In some aspects, the techniques described herein relate to an apparatus, wherein: the IPPK is independent of any basic service set identifier (BSSID) used by the wireless infrastructure equipment.

In some aspects, the techniques described herein relate to a method including: at wireless infrastructure equipment configured to communicate with a wireless client: upon establishing a connection to the wireless client without authenticating the wireless client, generating an individual probe protection key (IPPK) that is unique to the wireless client and independent of any basic service set identifier; storing the IPPK; sending the IPPK to the wireless client; upon receiving a probe request from the wireless client, computing a message integrity check based on the IPPK, and sending a probe response that includes the message integrity check to the wireless client; and upon the wireless client disconnecting from the wireless infrastructure equipment, deleting the IPPK.

In some aspects, the techniques described herein relate to a method, wherein: the wireless infrastructure equipment is configured to operate according to opportunistic wireless encryption (OWE) or open network authentication that does not use a password when establishing the connection to the wireless client without authenticating.

In some aspects, the techniques described herein relate to a method, wherein: establishing the connection includes receiving an open wireless encryption association request from the wireless client, and sending an open wireless encryption association response to the wireless client.

In some aspects, the techniques described herein relate to a method, further including, by the wireless infrastructure equipment: after establishing the connection without authenticating, performing a four-way handshake with the wireless client, wherein sending includes sending the IPPK in a message of the four-way handshake.

In some aspects, the techniques described herein relate to a method, further including, by the wireless infrastructure equipment: sending to the wireless client via the four-way handshake a beacon integrity group temporal key (BIGTK) used for protecting beacon frames.

In some aspects, the techniques described herein relate to a method, wherein the wireless infrastructure equipment includes a wireless access point configured to communicate with a network controller.

In some aspects, the techniques described herein relate to a method, wherein: storing the IPPK includes storing a mapping of the IPPK to an identifier of the wireless client.

In some aspects, the techniques described herein relate to a method, further including, at the wireless client: upon receiving the IPPK, storing a copy of the IPPK; sending the probe request to the wireless infrastructure equipment; and upon receiving the probe response from the wireless infrastructure equipment, validating the message integrity check using the copy of the IPPK.

In some aspects, the techniques described herein relate to a non-transitory computer readable medium encoded with instruction that, when executed by a processor of a wireless client configured to communicate with wireless infrastructure equipment, cause the processor to perform: upon connecting to the wireless infrastructure equipment without authenticating to the wireless infrastructure equipment, receiving from the wireless infrastructure equipment an individual probe protection key (IPPK) unique to the wireless client, and storing the IPPK; sending to the wireless infrastructure equipment a probe request; receiving from the wireless infrastructure equipment a probe response that includes a message integrity check; validating the message integrity check using the IPPK; and accepting or rejecting the probe response depending on a result of validating.

In some aspects, the techniques described herein relate to one or more non-transitory computer readable media encoded with instruction that, when executed by one or more processors of wireless infrastructure equipment configured to communicate with a wireless client, cause the one or more processors to perform: upon establishing a connection to the wireless client without authenticating the wireless client, generating an individual probe protection key (IPPK) that is unique to the wireless client and independent of any basic service set identifier; storing the IPPK; sending the IPPK to the wireless client; upon receiving a probe request from the wireless client, computing a message integrity check based on the IPPK, and sending a probe response that includes the message integrity check to the wireless client; and upon the wireless client disconnecting from the wireless infrastructure equipment, deleting the IPPK.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method performed by a wireless client configured to communicate with wireless infrastructure equipment, the method comprising:
upon connecting to the wireless infrastructure equipment without authenticating to the wireless infrastructure equipment, receiving from the wireless infrastructure equipment an individual probe protection key (IPPK) unique to the wireless client, and storing the IPPK;
sending to the wireless infrastructure equipment a probe request;
receiving from the wireless infrastructure equipment a probe response that includes a message integrity check;
validating the message integrity check using the IPPK; and
accepting or rejecting the probe response depending on a result of validating.

2. The method of claim 1, wherein:
when validating is successful, accepting the probe response; and
when validating fails, rejecting the probe response.

3. The method of claim 1, wherein:
the IPPK is independent of any basic service set identifier (BSSID) used by the wireless infrastructure equipment.

4. The method of claim 1, wherein:
the wireless client is configured to operate according to opportunistic wireless encryption (OWE) or open network authentication that does not use a password for connecting to the wireless infrastructure equipment.

5. The method of claim 4, wherein:
connecting without authenticating includes exchanging an open wireless encryption association request and an open wireless encryption association response with the wireless infrastructure equipment.

6. The method of claim 5, further comprising, by the wireless client:
after connecting without authenticating, performing a four-way handshake with the wireless infrastructure equipment,
wherein receiving the IPPK includes receiving the IPPK in a message of the four-way handshake.

7. The method of claim 6, further comprising:
receiving from the wireless infrastructure equipment via the four-way handshake a beacon integrity group temporal key (BIGTK) used for protecting beacon frames.

8. The method of claim 1, further comprising:
upon accepting the probe response, receiving, from a transmission source, a beacon that includes beacon-advertised access point capabilities;
matching the beacon-advertised access point capabilities against access point capabilities included in the probe response; and
trusting or not trusting the beacon based on a result of matching.

9. The method of claim 8, wherein:
when the result indicates a match, trusting the beacon; and
when the result indicates a mismatch, not trusting the beacon, and sending to the wireless infrastructure equipment a notification that the transmission source is a possible attacker.

10. An apparatus comprising:
a network interface unit to communicate with wireless infrastructure equipment; and
a processor coupled to the network interface unit and configured to perform:
upon connecting to the wireless infrastructure equipment without authenticating to the wireless infrastructure equipment, receiving from the wireless infrastructure equipment an individual probe protection key (IPPK) unique to the apparatus, and storing the IPPK;
sending to the wireless infrastructure equipment a probe request;
receiving from the wireless infrastructure equipment a probe response that includes a message integrity check;
validating the message integrity check using the IPPK; and
accepting or rejecting the probe response depending on a result of validating.

11. The apparatus of claim 10, wherein the processor is further configured to perform:
when validating is successful, accepting the probe response; and
when validating fails, rejecting the probe response.

12. The apparatus of claim 10, wherein:
the IPPK is independent of any basic service set identifier (BSSID) used by the wireless infrastructure equipment.

13. A method comprising:
at wireless infrastructure equipment configured to communicate with a wireless client:
upon establishing a connection to the wireless client without authenticating the wireless client, generating an individual probe protection key (IPPK) that is unique to the wireless client and independent of any basic service set identifier;
storing the IPPK;
sending the IPPK to the wireless client;
upon receiving a probe request from the wireless client, computing a message integrity check based on the IPPK, and sending a probe response that includes the message integrity check to the wireless client; and
upon the wireless client disconnecting from the wireless infrastructure equipment, deleting the IPPK.

14. The method of claim 13, wherein:
the wireless infrastructure equipment is configured to operate according to opportunistic wireless encryption (OWE) or open network authentication that does not use a password when establishing the connection to the wireless client without authenticating.

15. The method of claim 14, wherein:
establishing the connection includes receiving an open wireless encryption association request from the wireless client, and sending an open wireless encryption association response to the wireless client.

16. The method of claim 13, further comprising, by the wireless infrastructure equipment:
after establishing the connection without authenticating, performing a four-way handshake with the wireless client,
wherein sending includes sending the IPPK in a message of the four-way handshake.

17. The method of claim 16, further comprising, by the wireless infrastructure equipment:
sending to the wireless client via the four-way handshake a beacon integrity group temporal key (BIGTK) used for protecting beacon frames.

18. The method of claim 13, wherein the wireless infrastructure equipment includes a wireless access point configured to communicate with a network controller.

19. The method of claim 13, wherein:
storing the IPPK includes storing a mapping of the IPPK to an identifier of the wireless client.

20. The method of claim 13, further comprising, at the wireless client:
upon receiving the IPPK, storing a copy of the IPPK;
sending the probe request to the wireless infrastructure equipment; and
upon receiving the probe response from the wireless infrastructure equipment, validating the message integrity check using the copy of the IPPK.
